(19) United States
(12) Patent Application Publication
(10) Pub. No.: US 2006/0062008 A1
(43) Pub. Date: Mar. 23, 2006

(54) Dazzling lamp on air faucet of a wheel tire

(75) Inventor: Jui-Bin Hwan, Taipei Hsien (TW)

Correspondence Address: BACON & THOMAS, PLLC, 625 SLATERS LANE, FOURTH FLOOR, ALEXANDRIA, VA, 22314, US

(73) Assignee: GREAT PERFORMANCE INDUSTRIES CO., LTD., Taipei Hsien (TW)

(21) Appl. No.: 10/944,839

(22) Filed: Sep. 21, 2004

(51) Int. Cl. B60Q 1/26

(52) U.S. Cl. 362/500

(57) ABSTRACT

The present invention is related to a device used on an air faucet of a wheel tire, and especially to a dazzling lamp structure locked on an air faucet of a wheel tire. The dazzling lamp mainly comprises a main body, a power supply and a light-emitting member. In which the main body is locked on the air faucet of the wheel tire; the power supply and the light-emitting member are provided in the main body; the light-emitting member is provided on its two sides respectively with a light inductive element and a vibration inductive element; the vibration inductive element mainly makes conducting of a circuit through moving of an electric conductive member for contacting with an electric conductive sheet, thereby the dazzling lamp can lighten in running of the tire under a darker weather condition.

### BACKGROUND OF THE INVENTION

1. Field of the Invention

The present invention is related to a device used on an air faucet of a wheel tire, and especially to a dazzling lamp structure locked on an air faucet of a wheel tire to make the dazzling lamp on the tire be lightened during driving.

2. Description of the Prior Art

Cars generally are able to run on a road by rotation of wheels, each wheel mainly has a rim provided on a transmission shaft, and a tire tread is provided on the outer area of the wheel rim; by virtue that the tire tread is hollow, air must be pumped to push the tire tread to fix it on the wheel rim, so that the tire tread can roll on a road during rotation of the tire, thus a car can run on the road.

Therefore, the wheel rim must be provided thereon with an air faucet to pump air into the tire; normally, to avoid air from leaking off the air faucet, the air faucet must be provided with a locking cap in addition to a check means, so that gas leaking due to inadvertent collision can be avoided.

And more, generally when a car runs under a darker weather condition, it is subjected to having dead corners of viewing sight because of inadequate illumination, especially, situations at the two lateral sides of the car are unable to control by a driver; and by virtue that the car has no warning device on these two lateral sides, the environment of a darker weather condition or an inferior viewing sight is subjected to collision of cars, this is a big danger for the driver during driving.

### SUMMARY OF THE INVENTION

In view of the above problems, the inventor of the present invention provides a dazzling lamp on an air faucet of a wheel tire based on his professional experience of years in studying, designing and manufacturing same kind of products and after hard study and developing.

Thereby, the dazzling lamp on an air faucet of a wheel tire of the present invention mainly comprises a main body, a power supply and a light-emitting member. In which the main body is locked on the air faucet of the wheel tire; the power supply and the light-emitting member are provided in the main body; the light-emitting member is provided on its two sides respectively with a light inductive element and a vibration inductive element; the vibration inductive element mainly makes conducting of a circuit through moving of an electric conductive member for contacting with an electric conductive sheet, thereby the dazzling lamp can lighten in running of the tire at night.

The object of the present invention is: to render the light-emitting member lighten by simultaneously receiving the signals from the light inductive element and the vibration inductive element through induction of the light inductive element and rotation of the tire when a car runs in the state of being under a darker weather condition, thereby the car can get a better warning effect when it runs in the state of being under a condition of darker weather and inferior viewing sight.

The present invention will be apparent in its contents and effects to be achieved after reading the detailed description of the preferred embodiment thereof in reference to the accompanying drawings.

### BRIEF DESCRIPTION OF THE DRAWINGS

FIG. 1 is a perspective view of the present invention;

FIG. 2 is an analytic schematic perspective view of the present invention;

FIG. 3 is a sectional schematic view of the present invention;

FIG. 4 is a schematic view of an electric circuit of the present invention;

FIG. 5 is a perspective schematic view showing use of the present invention.

### DETAILED DESCRIPTION OF THE PREFERRED EMBODIMENT

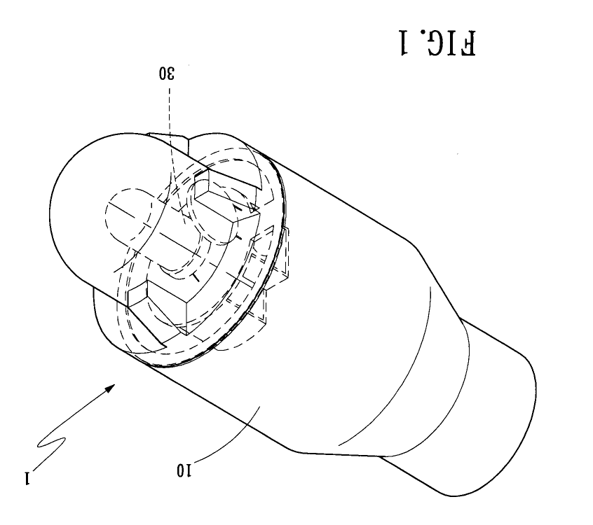

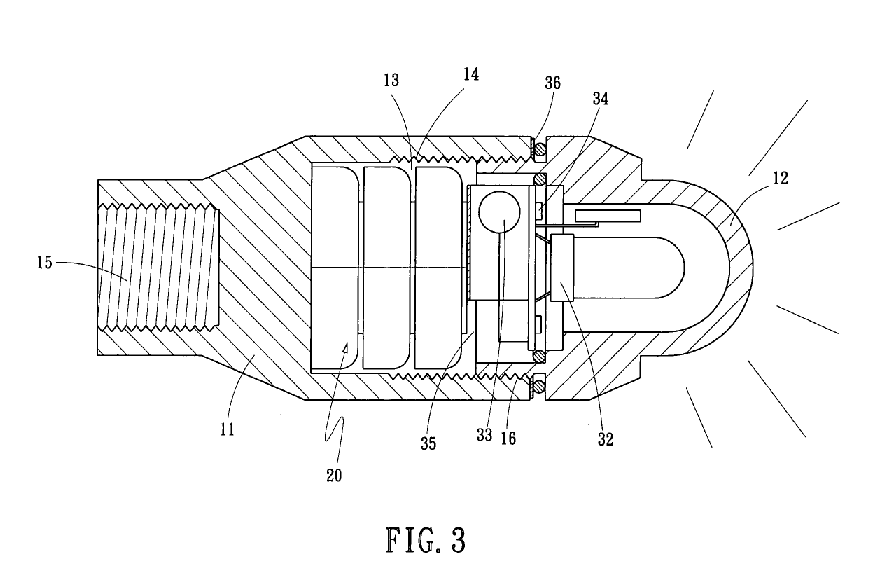

Referring firstly to FIGS. 1-3 showing the structure of a dazzling lamp on an air faucet of a wheel tire of the present invention; the dazzling lamp 1 mainly comprises a main body 10, a power supply 20 and a light-emitting member 30. In which:

The main body 10 is further comprised of a housing 11 and a cap 12; the housing 11 has on its front end a receiving recess 13 of which a wall has a first screw thread 14, and has on its rear end a second screw thread 15. The cap 12 is made of transparent material, and has on its rear end a screw-connecting portion 16 to be locked on the receiving recess 13 on the front end of the housing 11.

The power supply 20 mainly is provided in the receiving recess 13, and is composed of a plurality of batteries 21 for supplying electric power.

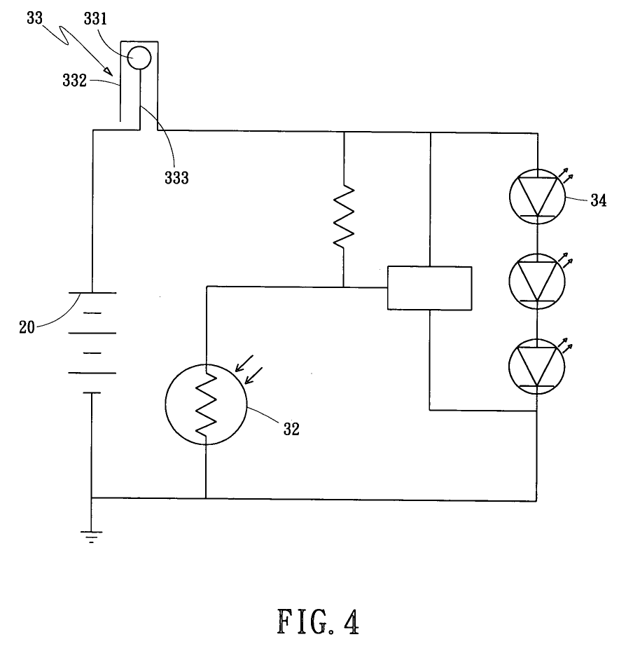

The light-emitting member 30 is provided in the cap 12, and mainly is provided at the two lateral sides of a base plate 31 with a light inductive element 32 and a vibration inductive element 33 respectively. Reference simultaneously to FIG. 4, the vibration inductive element 33 is mainly composed of a electric conductive member 331, a first electric conductive sheet 332 and a second electric conductive sheet 333; the second electric conductive sheet 333 is elastic and is provided in the first electric conductive sheet 332, the electric conductive member 331 is provided on the tailing end of the second electric conductive sheet 333 and is kept a suitable distance from the first electric conductive sheet 332. The base plate 31 is provided at least with an LED 34, and is provided on its end near the vibration inductive element 33 with an electric conductive plate 35.

Thereby, after the power supply 20 and the light-emitting member 30 are respectively received in the housing 11 and the cap 12, the cap 12 is locked on the first screw thread 14 on the front end of the housing 11 by means of the screw-connecting portion 16, so that the light inductive element 32 of the light-emitting member 30 can be provided in the receiving recess 13 of the housing 11; and the light-emitting member 30 in the receiving recess 13 can be conductively connected with the power supply 20 by means of the electric conductive plate 35; so that the power supply 20 can provide electric power for operation of the light-emitting member 30.

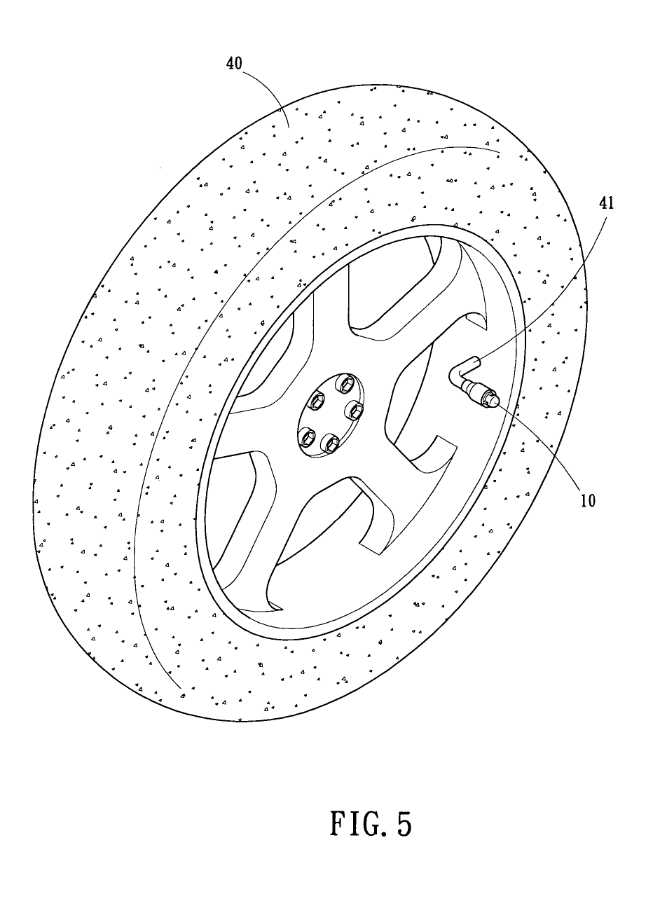

Please refer to FIGS. 4 and 5, the dazzling lamp 1 can be locked on an air faucet 41 of a tire 40 by means of the second screw thread 15 on the rear end of the housing 11, thereby during running of the car, the tire 40 can run by rolling on a road, and the dazzling lamp 1 and the tire 40 can be synchronically operated; now the electric conductive member 331 of the vibration inductive element 33 creates moving on the tailing end of the second electric conductive sheet 333 to make contact of the electric conductive member 331 with the first electric conductive sheet 332; thus the circuit is conducted to the base plate 31. However, by virtue that the light inductive element 32 is unable to operate in the environment of adequate brightness of normal daytimes, the circuit becomes a short circuit and the light-emitting member 30 is unable to lighten.

The light inductive element 32 can only make conductive of the circuit to transmit current to the base plate 31 under the environment of a darker weather condition with weaker light; and only when the light inductive element 32 and the vibration inductive element 33 are simultaneously conducted, the LED's 34 can be driven for operation to emit light beams, this makes rotating of the tire 40, and the dazzling lamp 1 can thus emit light beams to get the object of warning.

One thing worth mentioning, the electric conductive member 331 of the vibration inductive element 33 creates the effect of moving on the tailing end of the second electric conductive sheet 333 to form contact with the first electric conductive sheet 332 to make conductive of the circuit; on the contrary, a broken circuit forms. In this way, the car can make conductive of the circuit during driving, and forms a double switch together with the light inductive element 32, so that the dazzling lamp 1 can emit light beams through rotation of the tire 40 during driving at night.

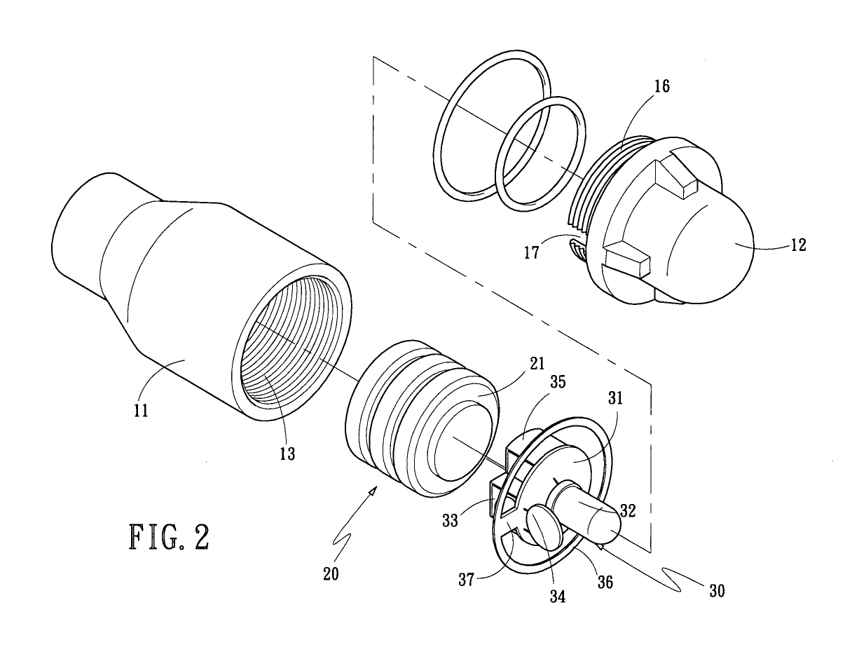

And more, referring again to FIG. 2, the base plate 31 of the light-emitting member 30 is provided externally thereof further with a slipping-over ring 36, the slipping-over ring 36 is connected with the base plate 31 by means of a connecting sheet portion 37; the slipping-over ring 36 can be slipped over the screw-connecting portion 16 of the cap 12, and the screw-connecting portion 16 is provided at a position in corresponding to the connecting sheet portion 37 with a notch 17, so that the connecting sheet portion 37 can be inserted into the notch 17, and the light-emitting member 30 can be fixed in the cap 12.

And please refer to all the drawings, the LED's 34 provided on the base plate 31 further are LED's with different colors, so that the light beams emitted from the dazzling lamp 1 can make variation of colors to increase the effect of warning of the dazzling lamp 1 on the tire.

By virtue that the dazzling lamp 1 is locked on the air faucet 41 of the tire 40, the dazzling lamp 1 can also be used as a cover for protecting the air faucet 41 to prevent the latter from gas leakage by inadvertent collision of an undue external force, thereby the security of the driver can be increased during driving.

While the names of the embodiment given are only for illustrating the present invention, and not for giving any limitation to the scope of the present invention; it will be apparent to those skilled in this art that various modifications or changes without departing from the spirit of this invention shall also fall within the scope of the appended claims.

1. A dazzling lamp on an air faucet of a wheel tire, said dazzling lamp comprises:
a main body locked on said air faucet of said wheel tire, said main body is comprised of a housing and a cap, said housing has therein a receiving recess;
a power supply provided in said receiving recess for supplying electric power;
a light-emitting member provided in said receiving recess, said light-emitting member has a base plate, and is provided at two lateral sides of said base plate respectively with a light inductive element and a vibration inductive element; said vibration inductive element is composed of an electric conductive member, a first electric conductive sheet and a second electric conductive sheet, said second electric conductive sheet is elastic and is provided in said first electric conductive sheet, said electric conductive member is provided on a tailing end of said second electric conductive sheet and is kept a suitable distance from said first electric conductive sheet, said base plate is provided at least with an LED 34, and is provided on its end near said vibration inductive element with an electric conductive plate connecting to said power supply.

2. The dazzling lamp on an air faucet of a wheel tire as in claim 1, wherein:
said housing has on its front end said receiving recess of which a wall has a first screw thread, and has on its rear end a second screw thread; said cap has on its rear end a screw-connecting portion to be locked on said receiving recess on said front end of said housing.

3. The dazzling lamp on an air faucet of a wheel tire as in claim 2, wherein:
said cap is made of transparent material.

4. The dazzling lamp on an air faucet of a wheel tire as in claim 1, wherein:
said power supply is composed of a plurality of batteries.

5. The dazzling lamp on an air faucet of a wheel tire as in claim 1, wherein:
said base plate of said light-emitting member is provided externally thereof further with a slipping-over ring, said slipping-over ring is connected with said base plate by means of a connecting sheet portion; said slipping-over ring thus is slipped over a screw-connecting portion of said cap, and said screw-connecting portion is provided at a position in corresponding to said connecting sheet portion with a notch, so that said connecting sheet portion is adapted to inserting into said notch, and said light-emitting member is fixed in said cap.

6. The dazzling lamp on an air faucet of a wheel tire as in claim 1, wherein:
said LED's provided on said base plate further are LED's with different colors, so that light beams emitted from said dazzling lamp is adapted to making variation of colors.

7. The dazzling lamp on an air faucet of a wheel tire as in claim 1, wherein:
said dazzling lamp is locked on said air faucet, said dazzling lamp thus is used as a cover for protecting said air faucet to prevent said air faucet from gas leakage by inadvertent collision of an undue external force.
